(19) United States
(12) Patent Application Publication
(10) Pub. No.: US 2007/0081518 A1
(43) Pub. Date: Apr. 12, 2007

(54) Open programmable software protocol stack for use with an Internet telephony system

(76) Inventors: Rajnish Jain, Plymouth, MA (US); David C. Brajczewski, Osterville, ME (US)

Correspondence Address: CESARI AND MCKENNA, LLP, 88 BLACK FALCON AVENUE, BOSTON, MA, 02210, US

(21) Appl. No.: 11/200,689

(22) Filed: Aug. 10, 2005

(51) Int. Cl. H04L 12/66

(52) U.S. Cl. 370/352

(57) ABSTRACT

An Open SIP Protocol Stack provides a variety of functions within a SIP-based telecommunications network. A set of cooperating layers including a transport layer, a transaction layer and a transaction user core layer. Various processes in these layers index into an associated configuration database designed in accordance with the present invention. The configuration database includes plurality of “mini-stacks.” When a particular transaction is being processed by one of the layers of the Open SIP Protocol Stack, PPL state machines that are to be utilized for that process are “loaded” with the appropriate information from the mini-stack for that attribute. Techniques for transaction processing and editing state machines are also provided by the Open SIP Protocol Stack of the present invention. The Open SIP Protocol Stack may be deployed in a SIP/PSTN gateway, a SIP Application Server, a SIP Media Server, a SIP Redirect Server and a SIP Registrar.

### BACKGROUND OF THE INVENTION

1. Field of the Invention

The present invention relates generally to internet telephony signaling protocols.

2. Background Information

While the demand by consumer and telecommunication providers for improved services using Internet telephony continually increases, the need for open and programmable systems is more critical compared to that need with respect to traditional telephony. More specifically, Internet telephony offers more functionality and flexibility and thus a greater scope for programmability than its traditional telephony counterpart. In addition, the most prevalent Internet telephony signaling protocol, i.e., the Session Initiation Protocol (SIP) is still rapidly evolving. Consequently, open systems are required to accommodate the rapidly evolving networks as well as the rapid adoption of changing international standards.

By way of background, SIP was developed within the IETF MMUSIC (Multi Party Multi Media Session Control) working group, with work proceeding since Sep. 1999 in the IETF SIP working group. Many RFCs have been issued which govern the usage of SIP. The most recent comprehensive RFC is RFC 3261, which is presently incorporated herein by reference in its entirety. As stated in RFC 3261, SIP operates in concert with other protocols by enabling Internet endpoints, known as “user agents” (UA) to communicate with one another and to agree on a characterization of a session they would like to share. For locating prospective session participants, and for other functions, SIP enables the creation of an infrastructure of network hosts (called proxy servers) to which user agents can send registrations, invitations to sessions, and other requests. SIP is a general-purpose tool for creating, modifying, and terminating sessions that works independently of underlying transport protocols and without dependency on the type of session that is being established.

SIP is an application-layer control protocol in the Internet Protocol model that can establish, modify, and terminate multimedia sessions, such as Internet telephony calls. SIP can also invite participants to already existing sessions, such as multicast conferences. Various kinds of media can be added to (and removed from) an existing session. SIP transparently supports name mapping and redirection services, which supports personal mobility users can maintain a single externally visible identifier regardless of their network location. SIP supports a number of facets of establishing and terminating multimedia communications including user location, user availability, user capabilities, session setup, i.e., “ringing”, establishment of session parameters at both called and calling party and session management, including transfer and termination of sessions, modifying session parameters, and invoking services.

Given that there exists a clear demarcation between the SIP protocol and the applications that it enables, the SIP protocol itself can be implemented as a generic, reusable, application-independent software protocol stack. A “protocol stack” generally refers to a particular software implementation of a computer networking protocol suite. The suite is the definition of the protocols and the stack is the software implementation of them. The SIP protocol stack module communicates with other modules, which are commonly described as “layers” in a stack of protocols. The lowest protocol deals with “low-level”, physical interaction of the hardware. Higher layers add more features. User applications habitually deal only with the topmost layers. In practical implementations, protocol stacks are often divided into three major sections for media, transport, and applications.

There are many different types of devices which communicate over the Internet using SIP. For example, a SIP phone can be used by an individual user. An inter-media gateway may use SIP on the Internet side of a telecommunication session, whereas the other caller may be coupled to the system via a public switch telephone network (PSTN) central office. A SIP server can also be interfaced with a large gateway or other device that is coupled to a wireless network, for example. For each of these types of devices and uses, a SIP stack using the SIP base protocol must be separately adapted for each device. Thus, in order to implement SIP for various types of devices, the software implementing SIP, which may be a SIP stack, typically needs to be rewritten at least in part each time there is a change in the system or a change in the parameters being used by the telecommunications system, and each time a customer has an individual request for a custom feature in that customer's own system.

In addition, traditional telephony involved an individual port or circuit to be dedicated to calls arriving into the system in a particular protocol format. For instance, in SS7 signaling networks, a voice circuit is statistically mapped to the Circuit Identity Code (CIC) that is carried in SS7 signaling messages. However, in the Internet telephony environment, calls can demand any media port and the appropriate signaling protocol must be available instantaneously to that port for the purposes of that Internet telephony session. In other words, Internet telephony sessions are created dynamically and have no permanent binding to media channels. Therefore, the design or requirements for configuration flexibility may be quite different using SIP than in circuit signaling stacks.

There remains a need therefore, for an open programmable software protocol stack that is configured to allow for user customization and dynamic adaptation of SIP messages for each Internet telephony session being handled by a telecommunications network or device.

There remains a further need for a SIP software protocol stack that can be configured and updated with a fine degree of granularity to accommodate a particular customer's needs.

### SUMMARY OF THE INVENTION

The present invention provides solutions to these and other disadvantages of prior techniques with an open, programmable software protocol stack that is referred to herein as the “Open SIP Protocol Stack.” The Open SIP Protocol Stack can be used in accordance with the invention within a variety of Internet communications systems. For example, the Open SIP Protocol Stack of the present invention may be deployed in a SIP/PSTN gateway, a SIP Application Server, a SIP Media Server, a SIP Redirect Server and a SIP Registrar. By “open” it is meant herein that the software is readily programmable and open to subsequent changes and reconfigurations.

The Open SIP Protocol Stack includes an associated configuration database that cooperates with a set of multi-layered finite state machines. The finite state machines are also user programmable. One type of environment in which the Open SIP Protocol Stack of the present invention can be employed is described in U.S. Pat. No. 5,546,453, of Hebert for a TELECOMMUNICATIONS SWITCH HAVING PROGRAMMABLE NETWORK PROTOCOLS AND COMMUNICATIONS SERVICES, which is hereby incorporated by reference as though fully set for herein.

More specifically, the Open SIP Protocol Stack is a layered software architecture, which includes a set of cooperating layers including a transport layer, a transaction layer and a transaction user core layer. Each of the layers invoke state machines to process instances of a transaction relating to a call that is being managed by the system. Various processes in the layers index into an associated configuration database designed in accordance with the present invention. The configuration database includes plurality of entries in a Session Group Profile Table, also referred to herein as “mini-stacks.” These mini-stacks each contain the data for a particular attribute of a call. The attribute may be the transport protocol in which the media is transmitted, or may the timer that applies to that particular call. A plurality of mini-stacks is constructed in accordance with the invention to accommodate the many hundreds of parameters that can describe a particular aspect of a call. When a particular transaction, such as a call, is being processed by one of the layers of the Open SIP Protocol Stack, the state machines that are to be utilized for that process are “loaded” with the appropriate information from the mini-stack that applies to that particular attribute.

In order to match the correct call as represented by its Call_ID with the correct data for that call, as represented by a call context, a novel transaction processing technique in accordance with the present invention uses a hashing function and hash table with the Call_ID as the input and the call context as the record to be obtained. This hashing technique allows for speed and reliability as well as a lower volume of storage being utilized for the session or transaction matching.

The Open SIP Protocol Stack of the present invention can also be configured to function as a SIP Registrar, which allows for registration functionality through which a client can utilize Registration techniques to perform many tasks and to avail of services available from the telecommunications provider that operates a device running the Open SIP Protocol Stack of the present invention.

The SIP Protocol Stack further includes processes whereby state machines can be edited dynamically to accommodate changing needs of the SIP entity or network in which the SIP Protocol Stack is used.

### BRIEF DESCRIPTION OF THE DRAWINGS

The above and further advantages of the invention may be better understood by reference to the following description in conjunction with the accompanying drawings, in which like reference numerals indicate identical or functionally similar elements:

FIG. 1 is a schematic block diagram of a SIP based network environment with which illustrative embodiments of a software protocol stack of the present invention may be advantageously employed;

FIG. 2 is a schematic illustration of the layered structure of the baseline SIP protocol;

FIG. 3 is a schematic block diagram of the layered software architecture for an illustrative embodiment of the Open SIP Protocol Stack of the present invention;

FIG. 4A is a conceptual call model with which illustrative embodiments of the present invention may be employed;

FIG. 4B is a schematic block diagram of an implementation of a Layer 3 and Layer 4 Call Model in which illustrative embodiments of the present invention may be advantageously employed;

FIG. 5 is a more detailed schematic illustration of the layered software model in which parsers can be used to parse the software protocol of the illustrative embodiments of the present invention;

FIG. 6 is a schematic block diagram of a network topology with multiple routes emanating from multiple entities that each utilize various illustrative embodiments of the protocol stack of the present invention;

FIG. 7 a flow chart of a procedure for processing a call in accordance with illustrative embodiments of the present invention;

FIG. 8 is a schematic illustration of inbound call handling using illustrative embodiments of the protocol stack of the present invention;

FIG. 9 is a schematic illustration of outbound call handling using stack illustrative embodiments the protocol stack of the present invention;

FIGS. 10A-10D illustrate the message flow and the corresponding state machine for producing each message that can be edited by the customer in accordance with the is illustrative embodiments of protocol stack of the present invention;

FIG. 11A is a schematic illustration of a hash function for transaction matching in accordance with the illustrative embodiments of the present invention;

FIG. 11B is a schematic illustration of a hash function in accordance with the present invention, for use with a Layer 3 user agent;

FIG. 12A is a schematic illustration showing the connection between address of records and contact addresses in the location service database of illustrative embodiments of the present invention;

FIGS. 12B and 12C illustrate alternative sites for the location service database in accordance with illustrative embodiments of the present invention;

FIG. 13 illustrates an address of record hash table in accordance with the illustrative embodiments of the present invention;

FIG. 14 is an example SIP message trace for normal registrations performed by illustrative embodiments of the SIP Registrar of the present invention;

FIG. 15 is an example of a SIP message trace for performing normal deregistrations in accordance with illustrative embodiments of the present invention;

FIG. 16 is an example of a SIP message trace for performing registration querying in accordance with illustrative embodiments of the present invention;

FIG. 17 is an example of a SIP message trace for performing registration modifications in accordance with illustrative embodiments of the present invention;

FIG. 18 is an illustrative SIP message trace for performing registrations with multiple contacts in accordance with illustrative embodiments of the present invention;

FIG. 19 is an example of a SIP message trace for performing third party registrations in accordance with illustrative embodiments of the present invention; and

FIG. 20 is an example of a SIP message trace for performing registration of nonadjacent contacts in accordance with RFC 3327 in accordance with illustrative embodiments of the present invention.

### DETAILED DESCRIPTION OF AN ILLUSTRATIVE EMBODIMENT

SIP Network Environment

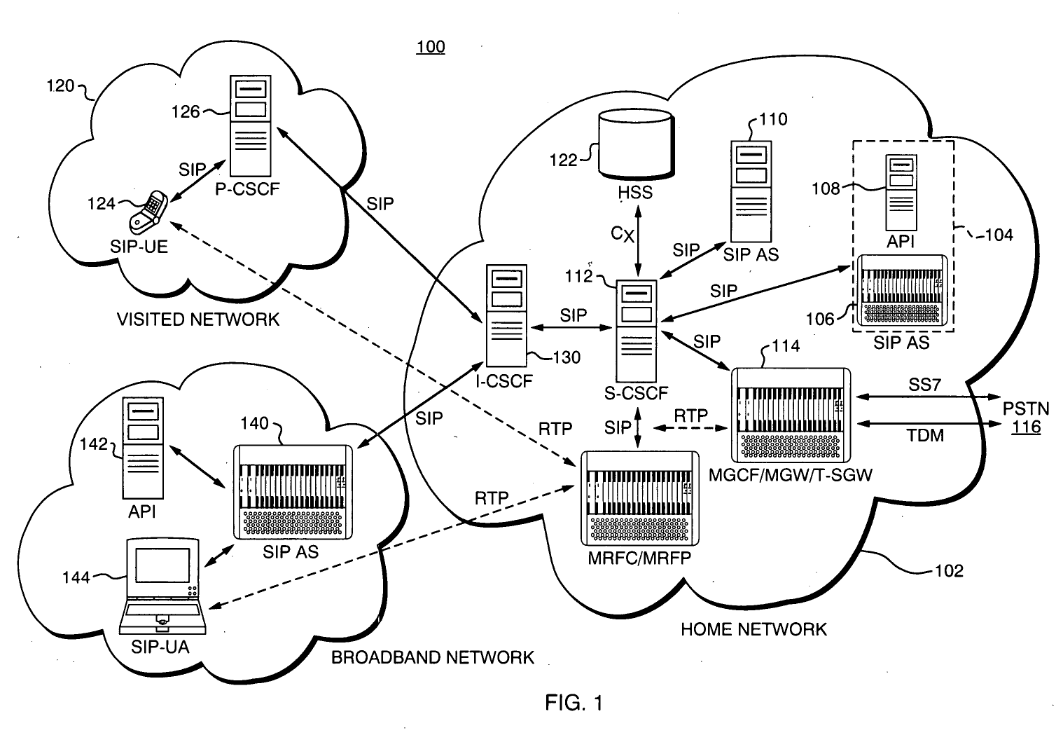

A SIP based network is comprised of primarily of two kinds of entities, namely user agents, and proxy servers. The Open SIP Protocol Stack of the present invention can be used in each of these entities. For purposes of a complete description, an illustrative environment in which the Open SIP Protocol Stack and associated database of the present invention can be employed is illustrated in FIG. 1. It should be understood, however, that the Open SIP Protocol Stack of the present invention and associated database can be used in many different types of entities in networks having a wide variety of architectures, and the invention is not limited to the network illustrated in FIG. 1.

FIG. 1 is a schematic block diagram of a SIP-based 3GPP network environment 100 that includes a home network 102 within which a number of components are communicating using SIP as the signaling protocol for Internet communications. The home network 102 may include a SIP application server 104 which may be comprised of a converged services platform 106 which is controlled by a host 108 using application program interface (API) messaging. Another SIP application server 110 communicates directly with a SIP proxy server for Service-Call Session Control Function (S-CSCF) 112. The protocol by which both SIP application server 106 and SIP application server 110 communicate with the S-CSCF 112 is the SIP protocol. A gateway 114 provides an interface between the PSTN 116 for any calls that are coupled to a user using a traditional PSTN telephone unit.

The S-CSCF 112 controls the overall operation of the home network 102. The S-CSCF 112 also acts as a SIP Registrar which registers requests sent by a user agent. For example, when a user travels outside of the home network 102, it may travel into a visited network 120. The visited network 120 includes it own proxy-call/session control function (P-SCSF) server 122, which receives and handles calls from a SIP user entity (SIP-UE) 124. The P-SCSF sends a registration request to the Registrar 112 which is routed to and from the proxy of the UA P-CSCF 122 to the proxy server in the home network, i.e., the interrogating-CSCF 130.

The I-CSCF 130 consults the HSS 132 (home subscriber server), in order to choose the registrar that will process the register request. A broadband network may also be coupled to the home network and the broadband network will also include a SIP application server 140 which communicates with a host 142 using API messaging and with a SIP user agent 144 using SIP.

Each of these SIP components uses a SIP signaling stack, but each type of component in each network has its own individual requirements for that type of entity in that type of network. The Open SIP Protocol Stack of the present invention can be used in each of these components in the SIP environment because it can be individually programmed and can adjust dynamically to varying requirements during runtime.

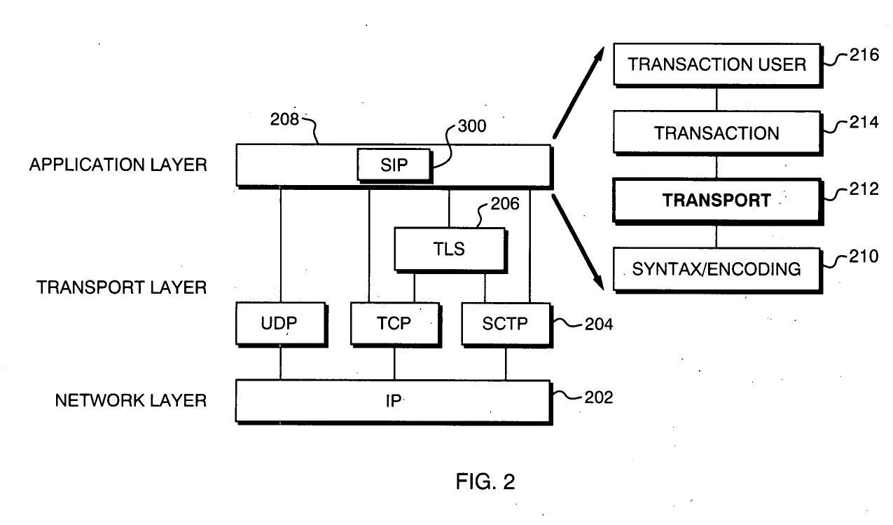

FIG. 2 illustrates the layered structure of the software that executes in each of the entities. This is the structure as described by RFC 3261. The first layer is a network layer 202, which may use, for example an Internet Protocol (IP) header for messages which arrive into the network layer. These messages are advanced to the transport layer 204, which processes and digests the transport portion of the packet depending upon whether it is being sent by the user data protocol (UDP), transmission control protocol (TCP) or the SCTP. An intermediate layer TLS 206 provides Internet security for information and messages sent in Internet sessions.

The highest layer is the application layer 208. Layer 208 comprises a number of sub-layers that include a syntax/encoding sublayer 210, a transport sublayer 212, a transaction sublayer 214 and a transaction user sublayer 216. This layered structure of the SIP protocol is per RFC 3261.

Software Architecture

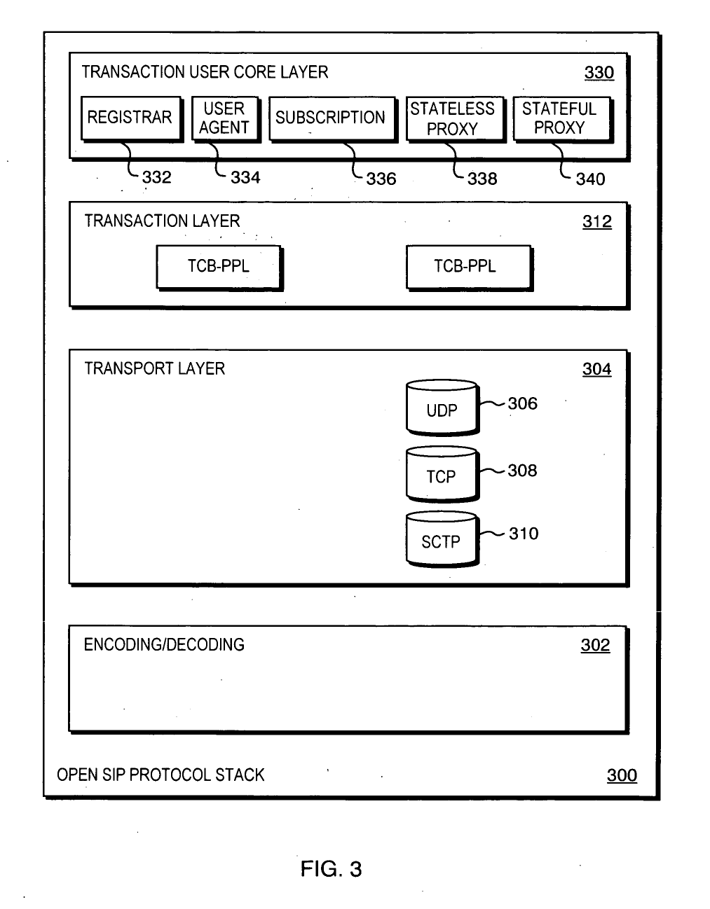

The Open SIP Protocol Stack 300 of the present invention resides in the application layer 208. More specifically, the Open SIP Protocol Stack 300 of the present invention is illustrated in FIG. 3. The Open SIP Protocol Stack 300 is a layered software structure which is comprised of software modules for separate functions. These modules are shown as individual software layers, and are thus referred to as “layers” herein. The first layer in the protocol stack 300 is an encoding/decoding layer 302. In accordance with one embodiment of the invention, a Session Description Protocol (SDP) Encoder/Decoder is used.

The next layer is the transport layer 304. In the transport layer 304, a transport parser ingests the incoming SIP INVITE message, and determines the transport protocol being used. In accordance with the invention, the transport layer 304 has access to multiple Session Group Profiles (SGPs), 306, 308, 310, as described hereinafter, which are illustratively implemented in a single table with multiple entries, and are used to control the behavior of the protocol stack 300 in accordance with the transport protocol of the transaction being processed.

A transaction layer 312 controls a variety of attributes of the transaction using Transaction Control Blocks (TCBs).

The transaction user core layer 330 of the Open SIP Protocol Stack 300 of the present invention, includes a Registrar module 332 which is a software process that acts as the SIP Registrar for the component as described in further detail herein. The transaction user core layer 330 also includes a user agent module 334 which controls the behavior of the protocol stack 300 when it is acting a user agent. A subscription module 336 is configured with information regarding subscription of telephony events within the telecommunications networks within which the Open SIP Protocol Stack 300 is being employed. There are other modules that may be implemented in the transaction user core layer 330, including, for example, Stateful Proxy Module 338, which is a logical entity that maintains the client and server state machines during the processing of a request. In addition, a Stateless Proxy Module 340 can be included, which is a logical entity that does not maintain the client or server state machines while processing requests, but simply forwards requests that it receives downstream and responses that it receives upstream, as appropriate. Other software modules may also be included to enhance the functionality of the transaction user core layer 330 of the Open SIP Protocol Stack 300 within the scope of the present invention.

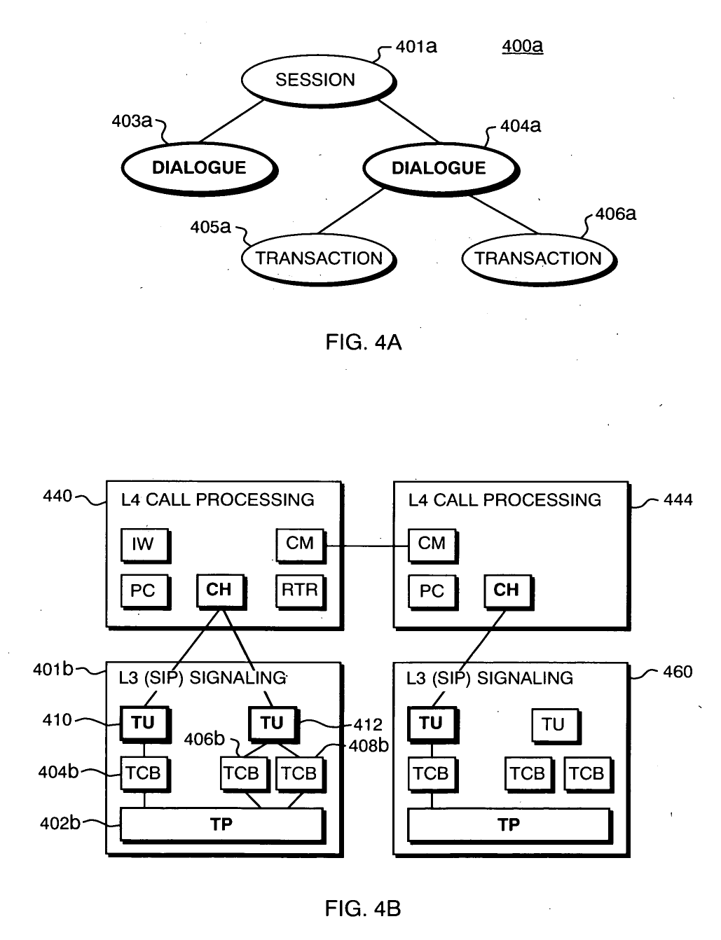

Call Model By way of further background, and as illustrated in FIG. 4A, the Open SIP Protocol Stack 300 employs a hierarchical conceptual call model 400A that includes objects such as sessions 401A, dialogs 403A and 404A and transactions 405A and 406A for managing various aspects of calls and sessions. The realization of the conceptual call model 400A in a B2 BUA (back-to-back user agent) system is illustrated in FIG. 4|_{[RJ1]}. . . A portion of the signaling layer (Layer 3) applicable to the calling party is illustrated in block 401B. This is a SIP signaling layer which includes the transport layer 402B. Transaction control blocks 404B, 406B and 408B are transaction instances. Transaction user objects 410, 412 represent information about the actual behavior (User Agent versus Proxy) of the call. Information is passed from the transaction user object in Layer 3 to the call processing layer 440. Connection management software communicates the information about the calling party to the corresponding layer representing the called party is (or the other entity in the transaction) for the other half of the call 444. The information about the called party is illustrated in the L3 signaling block 460.

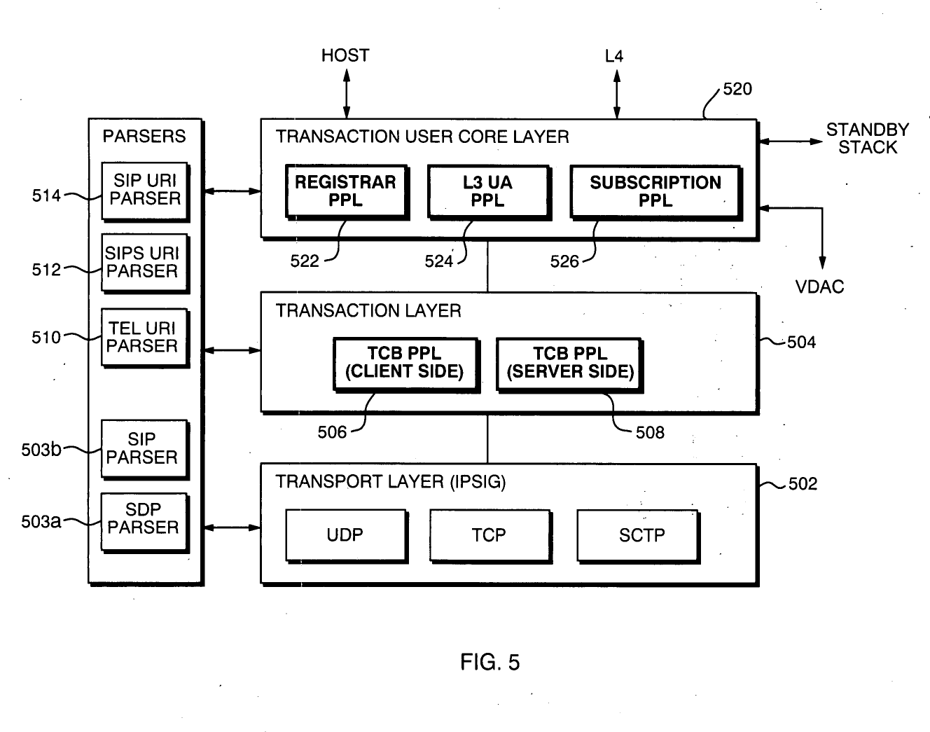

The relevant state machines which operate in the Open SIP Protocol Stack 300 for the functions illustrated in FIGS. 4A and 4B are shown in further detail in FIG. 5. The Transport Layer 502 is the IP signaling layer which digests a number of different transport protocols such as UDP, TCP and SCTP. A SDP parser 503a and a SIP parser 503b together digest the message from the Transport Layer 502 and strip off the transport layer header and interpret it and then pass the packet to the Transaction Layer 504.

The Transaction Layer 504 includes a client side transaction control block (TCB) and a server side TCB 508. The transaction layer also communicates with parsers 510, 512 and 514, which interpret the information from the Transaction Layer 504 and pass the remainder of the message to the Transaction User Core Layer 520. The Transaction User Core Layer includes the functionality for the entity to act as a SIP Registrar 522, a SIP User Agent 524 and a SIP Subscription module 526.

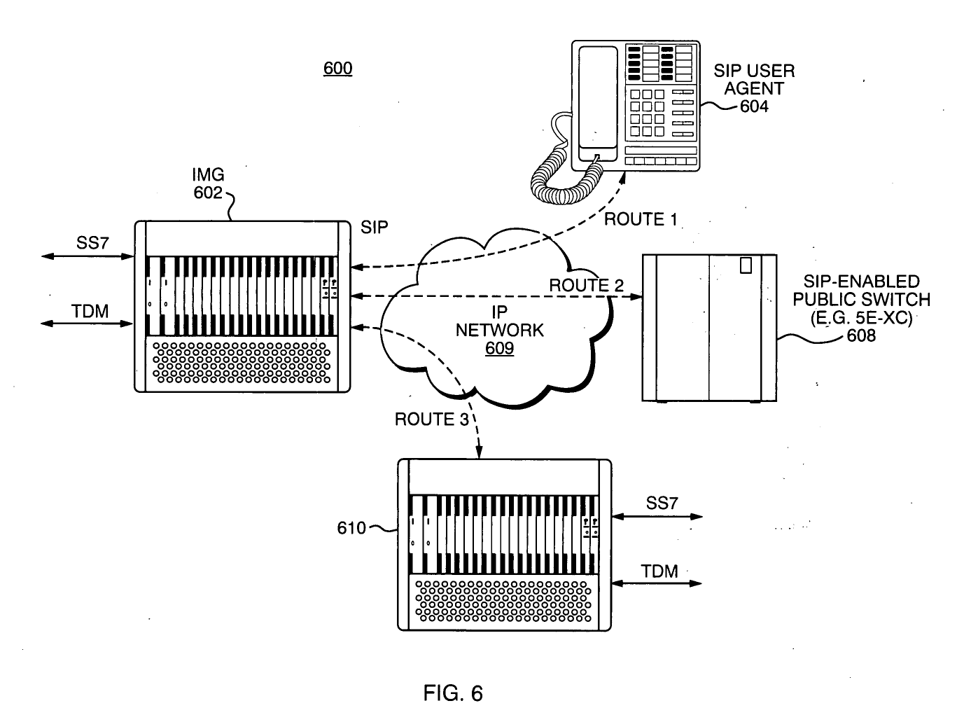

The software structure of FIG. 3 including the state machines of FIG. 5 can be used in a media gateway 602 in the environment 600 of FIG. 6. As noted one aspect in which the Open SIP Protocol Stack configuration of the present invention tends to differ from one entity to another is by route. The term “route” herein implies unique destinations such as user agents or proxy servers or network domains that necessitate different configuration information in the Open SIP Protocol Stack 300. The configuration information differs from route to route in terms of transport protocol for carrying SIP, default outbound proxy server, PPL protocol identification, PPL timers and the like.

Configuration Database

As illustrated in FIG. 6, a network topology 600 has multiple routes emanating from a SIP stack which is running on an integrated media gateway 602. More specifically, an integrated media gateway 602 is deployed in such a way that it is receiving calls from the SIP user agent 604, which is a SIP user phone on a desktop which would be used by a single user for example. A user may place five to ten calls per day using the SIP user agent telephone 604. The user is coupled by designated Route 1 to an integrated media gateway 602, which is running and executing the software stack of the present invention. A SIP enabled public switch 608 is also coupled by an IP network 609 to the integrated media gateway 602, as designated by Route 2. Notably, the SIP-enabled public switch 608 may be sending the gateway 602 fifty calls per second. Thus, Open SIP Protocol Stack of the present invention must be able to handle SIP calls from an individual desk set such as SIP user agents 604 which may send a few calls per day, but also with the SIP enabled public switch 608, which sends on the order of fifty calls per second. In addition, the integrated media gateway 602 is receiving calls from another gateway 610 which may be sending, for example, twenty calls per second, by way of Route 3.

Even though all three Routes, i.e., Route 1, Route 2 and Route 3 illustrated in FIG. 6 are using SIP, there are subtle differences between the way in which each of these three interfaces use SIP. The Open SIP Protocol Stack of the present invention is adjustable dynamically so that each of these entities can be accommodated. For example, where user agent 604 is only sending five to ten calls per day, there is no need for that entity 604 to establish a permanent TCP socket with the gateway 602. This will be an unnecessary use of resources within the gateway 602. Thus it makes sense that the SIP user agent calls are sent via the connectionless UDP transport protocol. In contrast, the SIP enabled public switch 608 will be sending many calls and thus in order to ensure reliability and ordering of the call signaling messages it is best that those calls are sent via TCP or SCTP. This change in transport protocol from UDP to TCP can be readily handled by the Open SIP Protocol Stack 300. To be able to capture this differing functionality from entity to entity within the same software structure, a configuration database is associated with the Open SIP Protocol Stack of the present invention. The configuration database is divided into smaller subsections that are mapped individually to each one of the bearer traffic entities, such as the SIP user agent entity and the public switch entity.

The individual subsections of the configuration database which are mapped to individual bearer traffic entities in a Session Group Profile (SGP) Table, which has multiple entries. The entries in the table are also referred to herein as “mini-stacks”. The types of bearer traffic entities which can be supported by the configuration database of the present invention are not just those shown in FIG. 6, but can include cellular telephones or other types of entities.

The mini-stacks can be configured based upon any attribute of the transaction/session. For example, mini-stacks can be based upon the appropriate timer to be used for a call. For example, a call which is being placed from one individual to another which is only a few blocks away will have a shorter propagation time than a call which is being placed to someone on the other side of the planet. In such an instance, the time that the packets take to traverse the Internet is significantly longer than the call which is occurring over a shorter distance geographically. Accordingly, multiple timers with differing timeout values can be maintained using the mini stacks of the present invention. Notably, an administrator or customer can determine which mini-stacks are useful in that particular customer's environment. Thus, a user interface is provided with the software whereby an administrator can select individual mini stacks which apply to its own particular installation in the field.

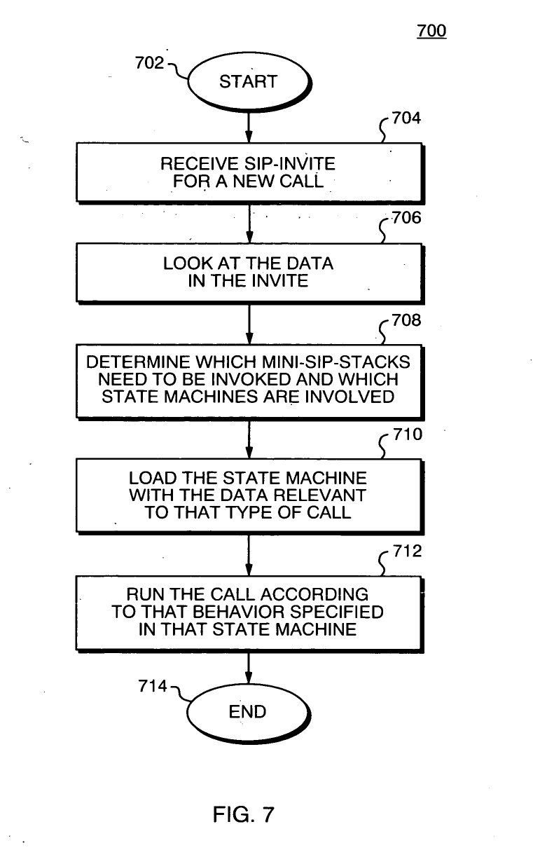

The use of the mini-stacks during a particular call or transaction can be better understood with reference to the flowchart of FIG. 7. FIG. 7 illustrates a procedure 700 which begins with the start step 702 and proceeds to step 704. When an incoming call is received at the entity which is operating the Open SIP Protocol Stack of the present invention, the component receives a SIP INVITE message for the new call, as shown in step 704. In accordance with step 706, the INVITE message is parsed and studied to determine the data in the INVITE message. In step 708, the system determines which mini stack needs to be invoked depending upon the attributes of the individual call. After this determination is made, the relevant state machines are loaded with the respective data from that applicable mini-stack for that particular type of call, as set forth in step 710. This allows for run-time binding of the call with the mini-stack for that particular type of call. In accordance with step 712, the system runs the call accordance with the behavior specified in the state machine that has been configured in accordance with the selected mini-stack. It should be understood that many state machines are involved with respect to many different attributes of a call, and this procedure will be followed for each of them. The procedure ends at step 714.

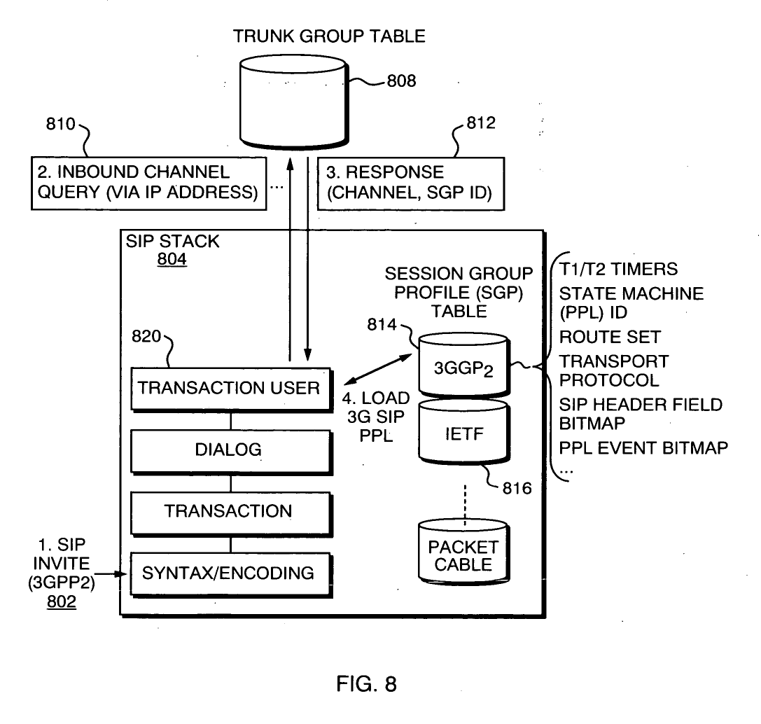

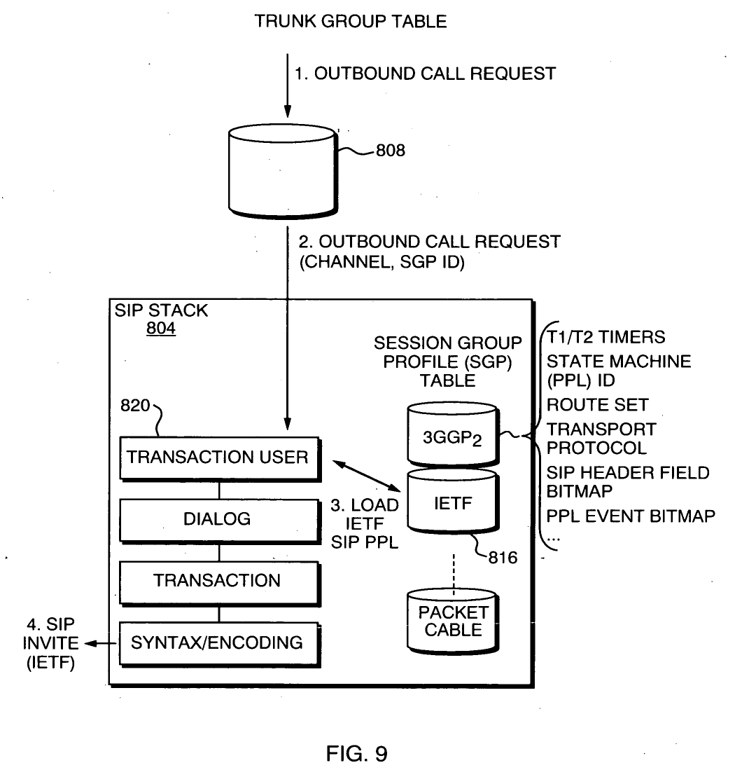

FIG. 8 and FIG. 9 provide examples for an inbound SIP call handling and outbound SIP call handling in this context. More specifically, referring to FIG. 8, an inbound call 802 is a 3GPP2 call from an S-CSCF 802. The call is received into a component which is running the Open SIP Protocol Stack of the present invention which is illustrated in block 804. In the example of FIG. 8, the outbound call is a basic IETF SIP call.

When handling the inbound portion of the call, the Open SIP Protocol Stack of the present invention 804 first accesses a trunk group table 808 also known as a Layer 4 router based upon one or more keys. In this example, the key is shown as inbound channel query via IP address 810. The result of the trunk group table look up is a physical/virtual channel identifier as well as the session group profile (SGP) identifier. In other words, the mini-stacks that are applicable to that portion of the call are identified.

This is illustrated as item 812 in FIG. 8. The mini-stacks store identifiers and other configurations specific to a particular class of endpoints. In other words, the profile identifies the particular mini-stack involved in the call that is being placed. In the example, two mini-stacks are involved. The 3GPP2 mini stack 814 is needed for the incoming portion of the call. The IETF mini-stack 816 applies to the outbound portion of the call. Thus, the mini-stack 814 for the 3GPP2 is loaded into the transaction user state machine illustratively illustrated in the block 820. The inbound call is thus handled using the 3GPP2 mini-stack 814.

Similarly, FIG. 9 illustrates the outbound side of the call. The outbound call request is received at the trunk group table 808. The particular mini-stack needed for processing the outbound call (IETF stack 816) is identified. The relevant information is loaded into the transaction user state machines in the transaction user layer 820 of the Open SIP Protocol Stack 804. As a result, the outbound call request with the appropriate mini-stack is loaded and executed. Accordingly, this allows run time binding of an incoming/outgoing call to an SGP ID (mini-stack identifier) which leads to the state machine variant and other configuration data that differs from endpoint to endpoint. In this way a single protocol instance can handle diverse protocol variants in accordance with the present invention.

User-Editable State Machines

The Open SIP Protocol Stack 300 (FIG. 3) of the present invention also allows individual state machines to be edited. In prior systems, it was possible to include a supplemental state machine for a variant and this state machine was utilized for calls that needed a particular variant for processing. However, that involved writing the software for each particular variant that was expected to be encountered. The Open SIP Protocol Stack of the present invention allows a change to be made to the state machine during run time.

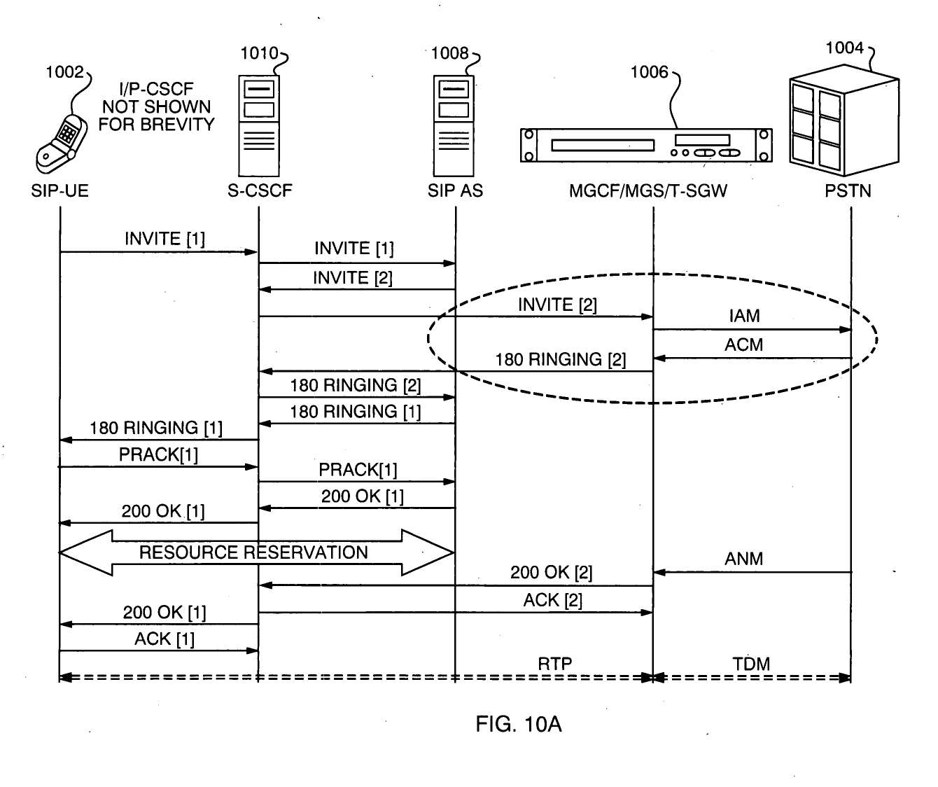

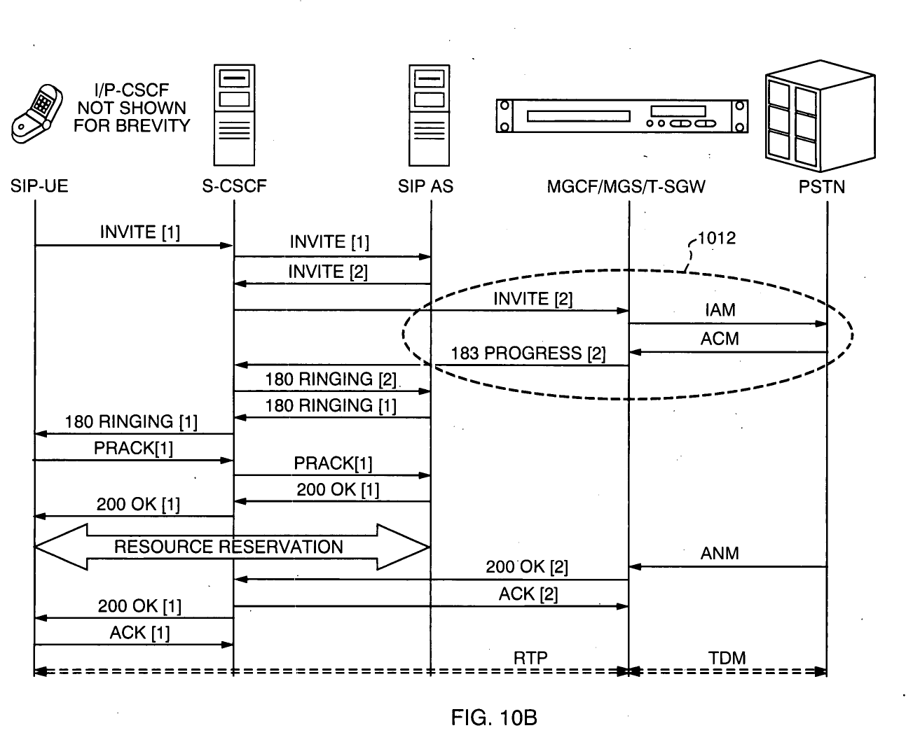

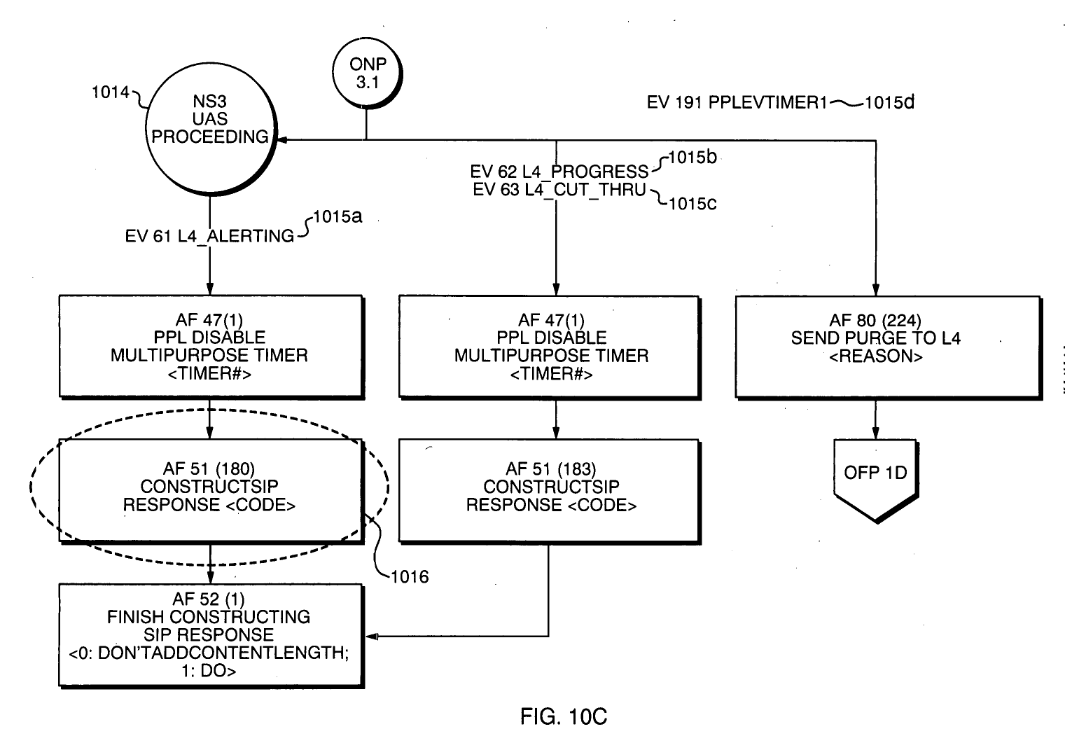

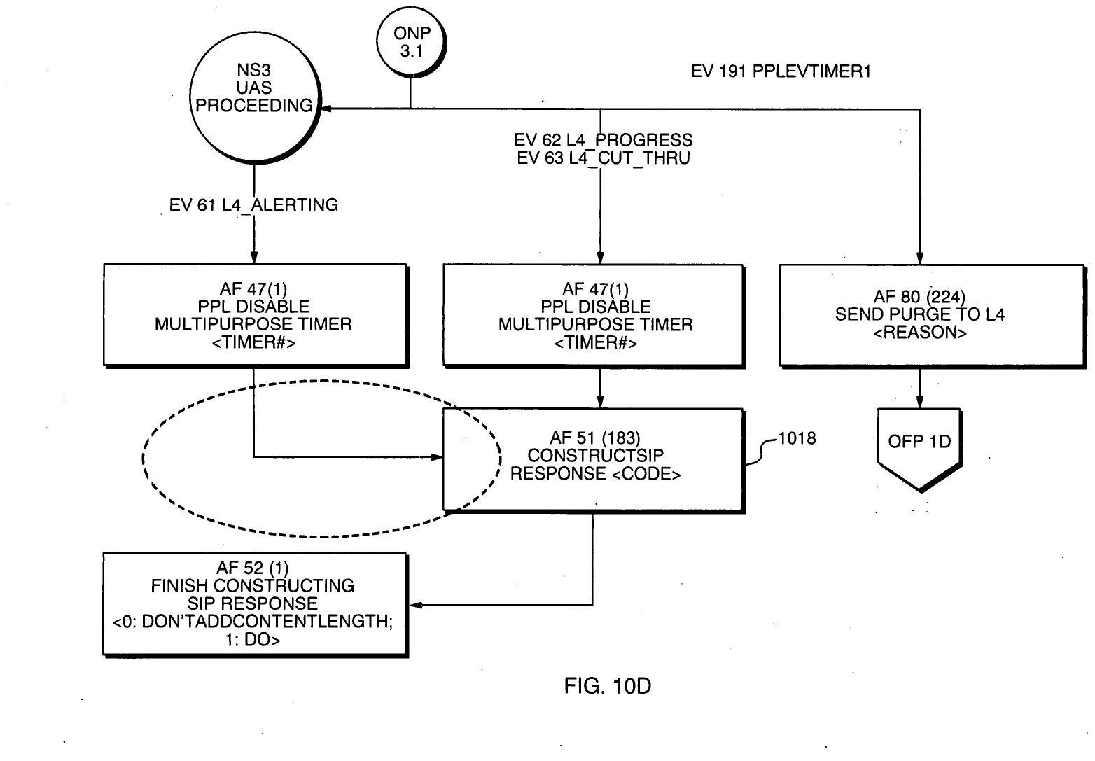

By way of illustration, and not of limitation, FIGS. 10A through 10D illustrate how a state machine can be edited. In the example, the message to be sent in a particular circumstance is changed. In FIG. 10A, a SIP User Entity (UE) 1002 is communicating with a party coupled to the PSTN 1004. A gateway 1006 provides an interface between the PSTN and the Internet. More specifically, a SIP Application Server 1008 receives a message from the gateway 1006 and passes this message to a C-CSCF Proxy Server 1010, which in turn passes messages back to the user entity 1002. In the example, a series of SIP INVITE messages ultimately result in an IAM message being sent by the gateway 1006 to the PSTN 1004 to initiate a call. In response, in the normal setting, the PSTN 1004 sends an acknowledgement message ACM to the gateway 1006 which in turn sends a 180 RINGING message in SIP protocol which is passed in turn to each of the SIP entities.

For purposes of the example, it is assumed that the administrator intends to modify this behavior to accomplish “early media”, where the speech path is connected within the gateway at the start of ringing stage of the call. This allows for announcements or ring back tones coming from the remote end to be heard by the caller. “Early-media” is a common practice in international calls due to heterogeneous networks in a call path inband indications from the remote-end are more reliable than certain signaling information, which is subject to loss due to various translations along the call path. The behavior can be modified using the Open SIP Protocol Stack 300 of the present invention to change the 180 RINGING message to a 183 Progress message 1012 as shown in FIG. 10B.

The normal default behavior is controlled by the state machine illustrated in FIG. 10C. More specifically, the Open SIP Stack 300 sits between the network and Layer 4 of the software. The Open SIP Stack 300 provides message to Layer 4 depending upon particular events that affect the state. In FIG. 10C, the UAS (User Agent Server) 1014 is a state. The state 1014 can be effected by any of one of four different events, i.e., EVENT 61, which is a L4 Alerting Event 1015a, EVENT 62, which is and L4 Progress event 1015b, EVENT 63 which is an L4 Cut Through event 1015c and EVENT 191 which is a PPL event timer1 1015d. In this example, the L4 Alerting event is invoked. This causes the call flow to proceed via a timer finction to Atomic Function 51, identified in block 1016, which has been circled for clarity of illustration. The Atomic Function 51 has a “180” argument that indicates that a 180 Ringing message should be constructed and transmitted as a SIP response.

A modification can be performed in accordance with the present invention such that, as shown in FIG. 10D, the Atomic Function 51 having the (180) argument has been deleted (as designated by the blank circle). Instead the state machine proceeds to atomic function 1018 which bears a (183) argument, which indicates that a 183 Ringing message should be constructed and sent as a SIP response. Thus, it should be understood that a simple modification to the state machines can be made to alter the call flow in order to accommodate varying circumstances in which the Open SIP Protocol Stack 300 of the present invention is implemented.

Transaction Processing

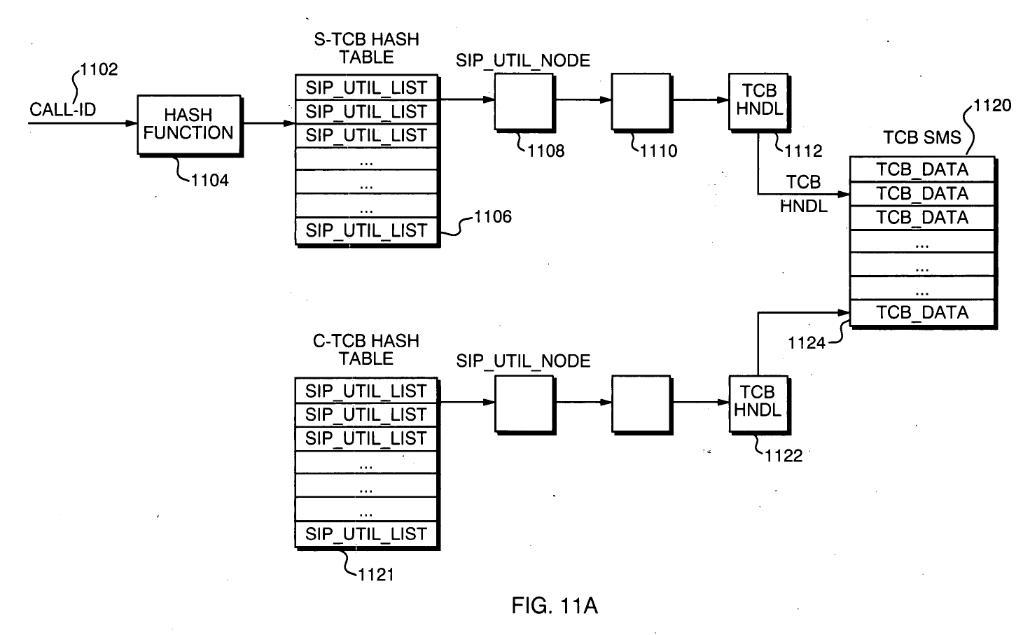

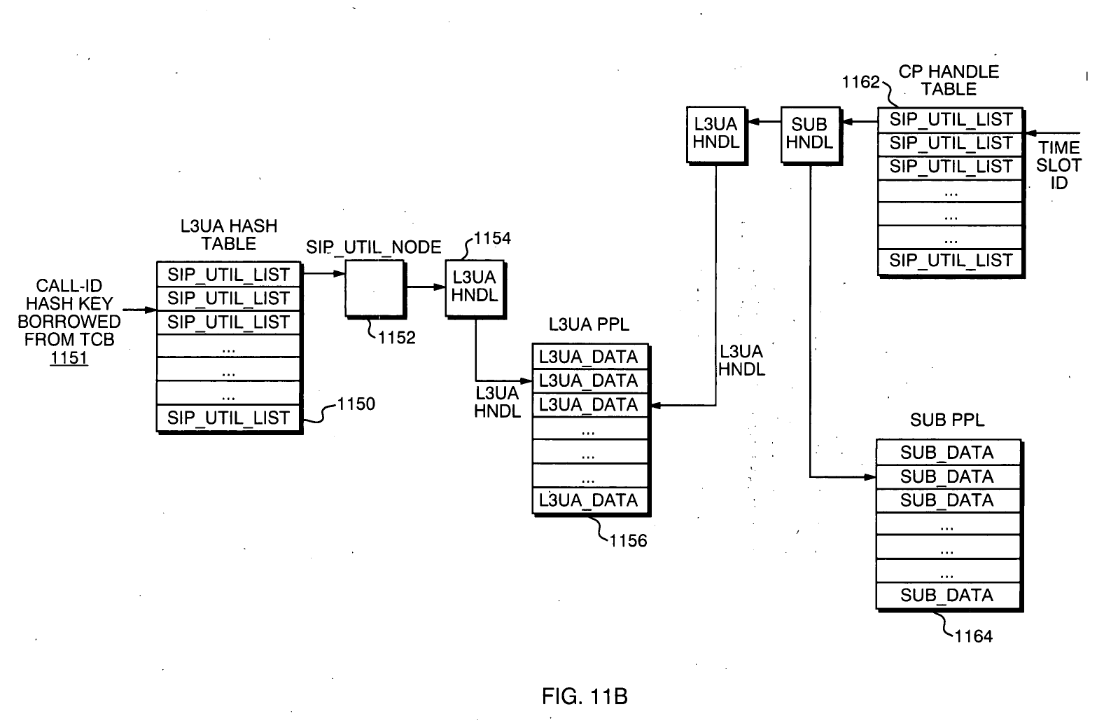

The Open SIP Protocol Stack 300 of the present invention also includes a novel technique for transaction processing. A transaction instance is represented by a TCB (Transaction Control Block). TCBs exhibit finite state machine behavior, and are therefore can be implemented using PPL. TCBs are broadly categorized as Server-TCBs (S-TCB) and Client-TCBs (C-TCB). A TCB handle is associated with the data stored for that particular transaction, such as a call context. For example, during the progress of a call, subsequent messages arrive at the server or other entity processing some aspect of that call, and these message pertain to that call, but the Open SIP Protocol Stack must correlate the subsequent messages with the individual call context to which it belongs, so that the message is processed with respect to the correct call. Thus, TCB handle must be matched to the correct data records in the database, and there may be tens of thousands of such records to be matched, and this matching is to be accomplished as quickly as possible. Thus, transaction matching is a critical part of any SIP entity implementation. FIG. 11A illustrates how transaction matching is accomplished by the Open SIP Protocol Stack of the present invention.

A Call-ID 1102 is an input to a hash function module 1104. The hash function 1104 compresses the Call-ID string, which may be a string of many characters, into a smaller string in accordance with a suitable hashing algorithm to obtain a hash value. A Server TCB hash table 1106 contains all of the compressed data representing the hash value for each transaction that is ongoing. An incoming Call-ID is to be matched against the entries in that table, using a suitable hash key. A Call_ID is a unique piece of text that is assigned to every call, and is a character string that may include up to 100 characters or more.

As will be understood by those skilled in the art, more that one item can satisfy the hash key. This results in a hash collision. In the example of FIG. 11A, a hash collision has resulted in three possible TCB handles 1108, 1110 and 1112, each of which satisfies the hash key. These possible TCB handles are then matched against the original Call_ID string to determine the correct handle that applies to that particular transaction. In the example, the TCB Handle 1112 is the correct one. Thus, it is used to locate the correct data record in the table 1120 that applies to that transaction. It is typically a call context record. Similarly, on the client side, a search is conducted against the C-TCB Hash Table 1121 to determine the correct TCB handle 1122 that points to the applicable data 1124 in the table 1120. Accordingly, the correct data can be quickly obtained without needing to conduct a serial search.

Other layers of the Open SIP Protocol Stack 300 also require locating data records out of many such records. These layers may also employ a hashing technique. For example, FIG. 11B illustrates a Layer 3 User Agent Hash Table 1150. A Call-ID hash key 1151 is borrowed from a TCB and used as an input to the hash table 1150. This results in one or more Layer 3 UA handles, 1152, 1154. Once the correct handle is identified, it is used to point to the correct L3 UA data in the L3 US PPL table 1156. In addition, this hash table 1150 can be indexed in another way whereby using, for example a Time Slot ID, instead of a Call-ID. I this way, CP Handle Table 1160 may be used to obtain similar data from the PPL table 1162, or Sub-Data from the SUB PPL table 1164.

Registration

Registration entails sending a REGISTER request to a registrar. A registrar acts as the front end to a location service for a domain, reading and writing mappings based on the contents of REGISTER requests. A proxy server that is responsible for routing requests for that domain then typically consults this location service. REGISTER requests add, remove, and query bindings. A REGISTER request can add a new binding between an Address of Record (AOR) and one or more contact addresses. A suitably authorized third party can perform registration on behalf of a particular AOR. A client can also remove previous bindings or query to determine which bindings are currently in place for an AOR.

The Open SIP Protocol Stack of the present invention can be configured to perform registration functions whereby a client can bind an AOR as identified by its SIP Uniform Resource Identifier (URI) to one or more Contact Addresses (also identified by a SIP URI). The registration module 332 is illustrated in the Transaction User Core Layer 330 of the Open SIP Protocol Stack 300 of FIG. 3. This registration module 332 is sometimes referred to herein as “the SIP Registrar.”

Ihis regard, the Open SIP Protocol Stack of the present invention will have been downloaded on to a suitable component, such as a converged services platform (CSP) which is thus programmed to act as a SIP Registrar. A suitable CSP is commercially available from Excel Switching, Inc. of Hyannis, Mass. USA. The CSP acts as a programmable SIP Registrar giving host developers control for creating a host or switch resident location service. In this way, the Open SIP Protocol Stack of the present invention handles incoming registrations. Decisions about where the bindings are created can be left open for host developers to determine, depending upon a particular application of the invention.

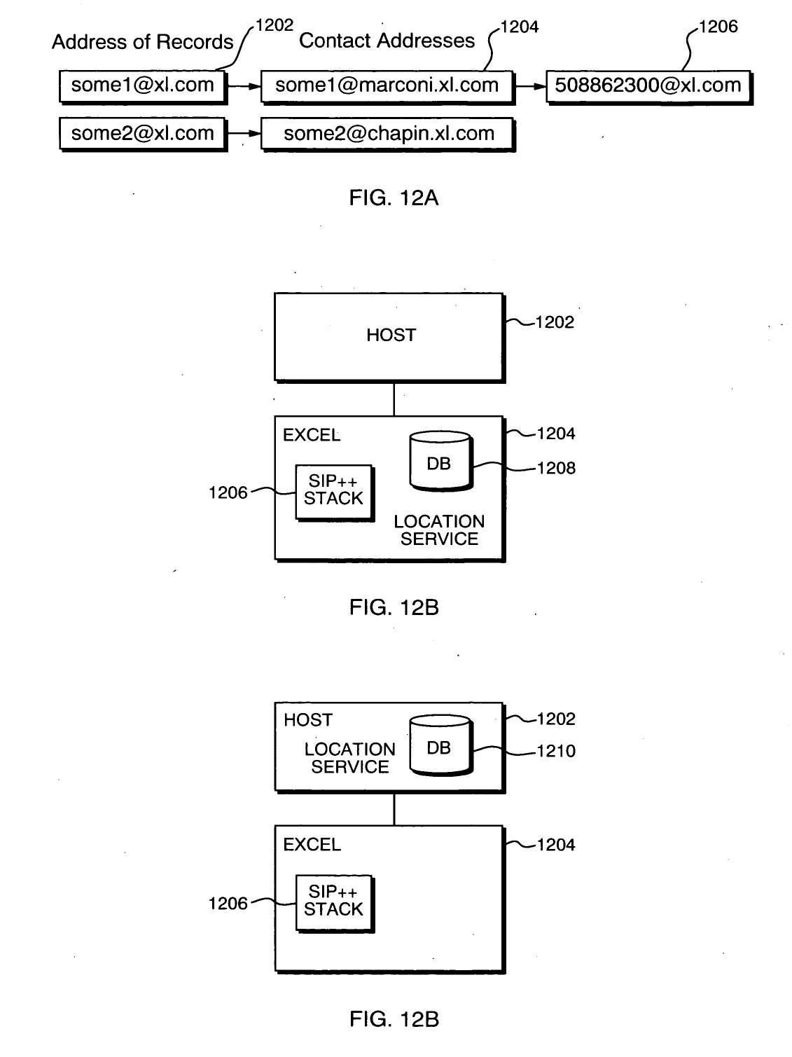

FIG. 12A illustrates how an AOR can be bound to a Contact address in a location is service database. The address of records table 1202 includes URIs that is bound to contact addresses in the table 1204. The third item 1206 is a second contact address for the subscriber identified at address of record 1202.

FIGS. 12B and 12CB illustrate two example of where the location service database may be deployed. In the illustrative embodiment shown in FIG. 12B, a host computer 1202 communicates with a telecommunication switch or services platform 1204 for telecommunications services. The switch 1204 may be acting as proxy server, or other suitable entity in a SIP network environment. The Open SIP Protocol Stack 1206 of the present invention is executing on the switch 1204. In this embodiment, a Location Service Database 1208 is resident in the memory of the switch 1204.

In the illustrative embodiment depicted in FIG. 12C, the Location Service Database 1210 is resident on the host computer 1202, which in turn communicates with the switch 1204.

The database may contain tens of thousands of records. In accordance with the present invention, the Open SIP Protocol Stack of the present invention includes a hashing function in order to increase the speed of searching the Location Service Database for the desired information when performing registration functions.

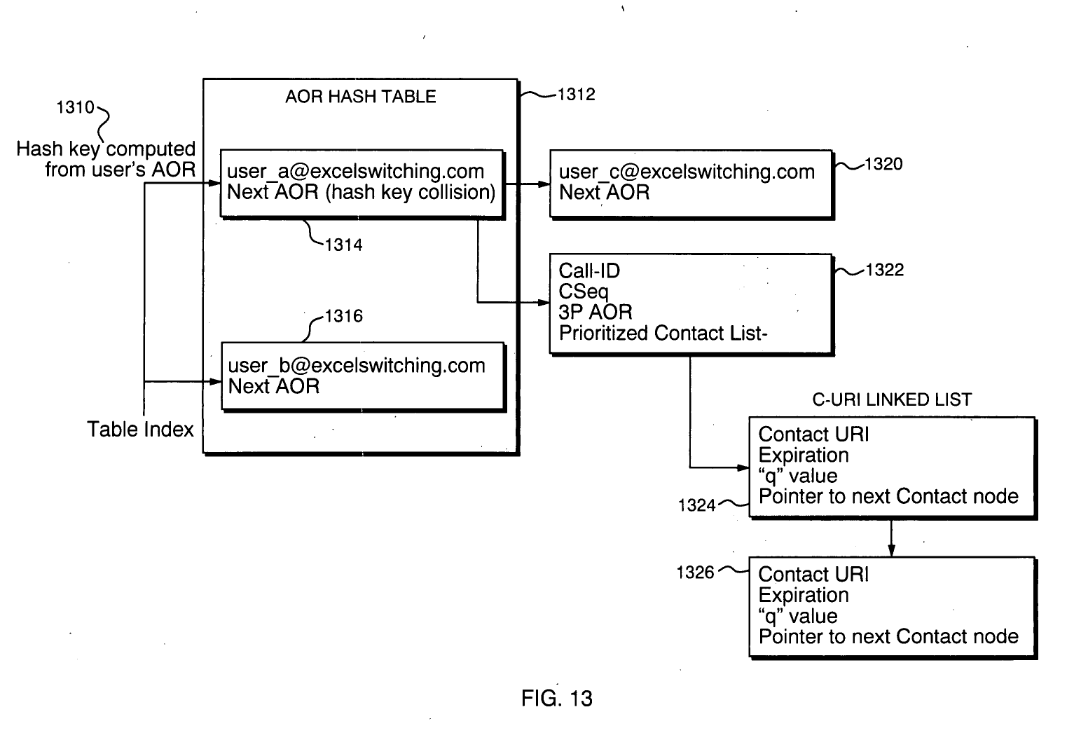

As illustrated in FIG. 13, a hash key 1310 is an input to a hash table 1312. A search engine compares the hash key 1310 to the stored hash keys 1314 and 1316 of all of the users of the service. If there is one match, then that is the desired user contact address. If there is a hash collision, then as suitable algorithm, or a bit by bit comparison is made. Once the correct contact address information 1320 is obtained, it is matched with the associated Call ID 1322. A C-URI Linked List is then used to obtain each Contact Address to which the AOR is bound. In the example of FIG. 13, the Open SIP Protocol Stack of the present invention functions to bind the AOR of “user_a” to the Contact Addresses 1324 and 1326, for example.

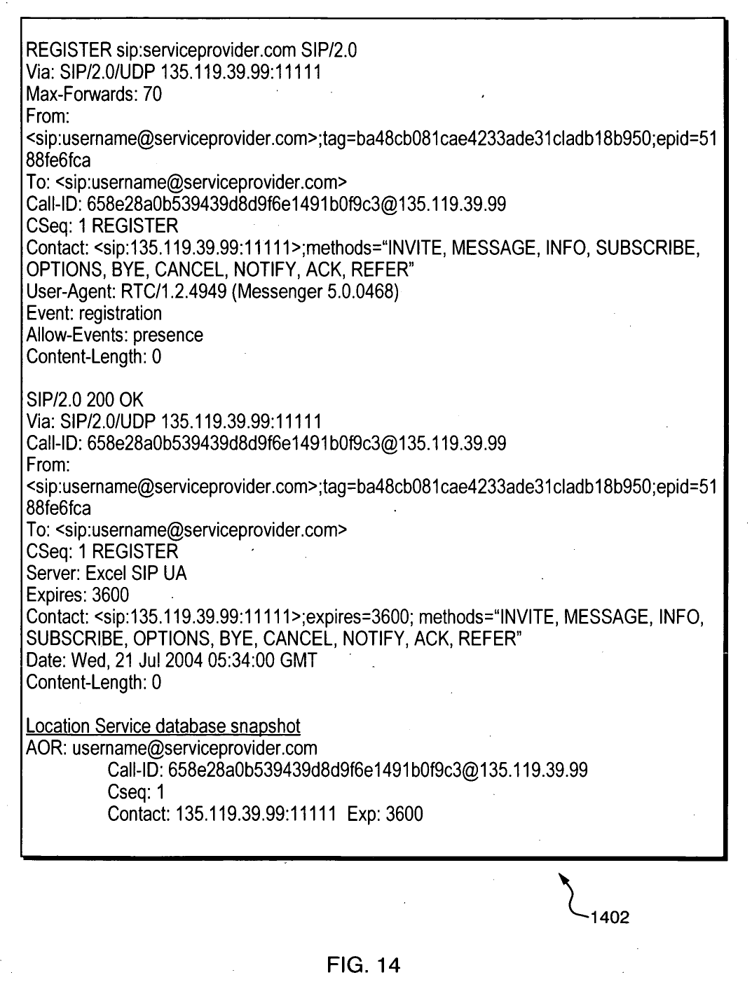

The Open SIP Protocol Stack of the present invention includes further SIP Registrar functionality. The SIP message traces set forth in FIGS. 14 through 20 are illustrative of the SIP message traces that the SIP Registrar of the present invention uses to implement certain functionality. SIP is an ASCII-based protocol and thus message traces can be readily developed to handle other functions though not illustratively described herein, is which functions are to be performed by the SIP Registrar of the present invention, and thus it is expressly contemplated that such other function are within the scope of the present invention.

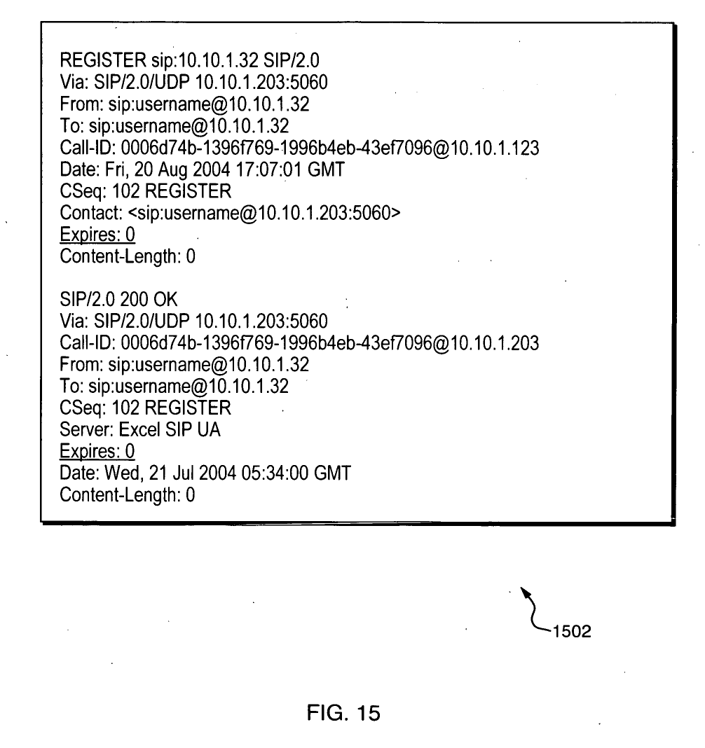

FIG. 14 depicts an illustrative SIP message trace 1402, which can be used to conduct normal registrations. FIG. 15 illustrates SIP message trace 1502 for performing normal de-registrations in the system.

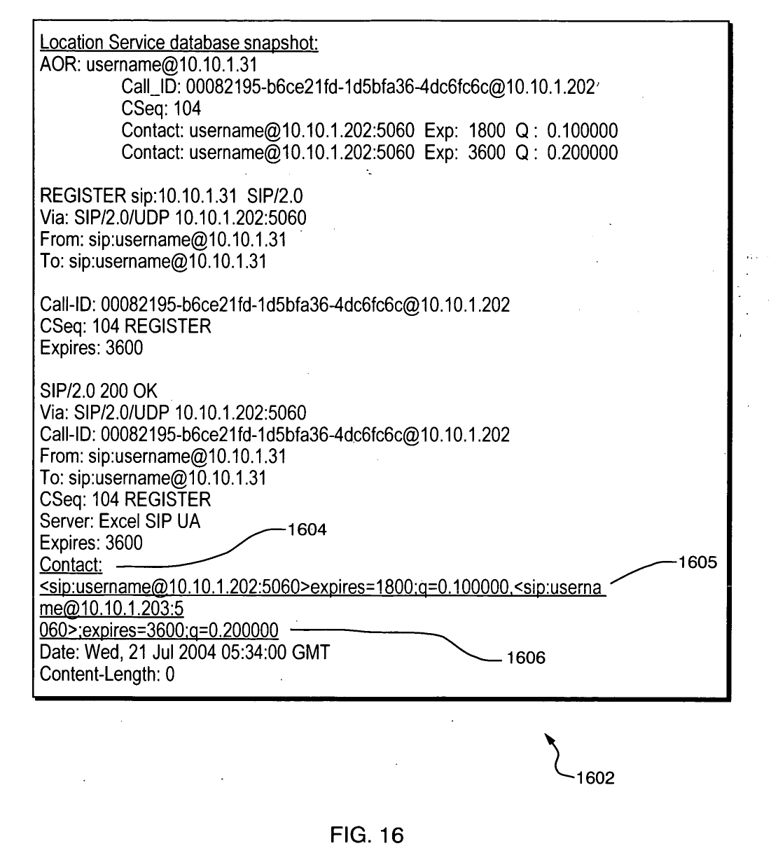

With reference to FIG. 16, it is noted that a registration, which is an entry in location service database) is a critical piece of information about a SIP user that needs to be accessed by various entities including proxy servers, application servers or other users that have subscribed for the user's presence events. A simple way to query one's own registration information, by the user or by an allowed third party, is to send a SIP REGISTER request to the Registrar without including the Contact header field as illustrated in the exemplary SIP message trace 1602. Using this method avoids user inadvertently modifying the registration record in the location service database.

The Open SIP Protocol Stack of the present invention supports a few additional ways to query registration entries in its location service database. These include, EXS/NG API based query mechanisms. In addition, RFC 3680 which describes an event package for registrations through which a SIP user can subscriber for registration events of another user (a capability typically used by presence applications), can also be supported.

The example of FIG. 16 shows a SIP REGISTER request that queries the user's own registration record in the location service database. The response from the SIP Registrar of the present invention contains all the contact addresses with expiration duration for each and the “q” values for each (if any) that are bound to the user's AOR, as illustrated in lines 1604-1606 of block 1602.

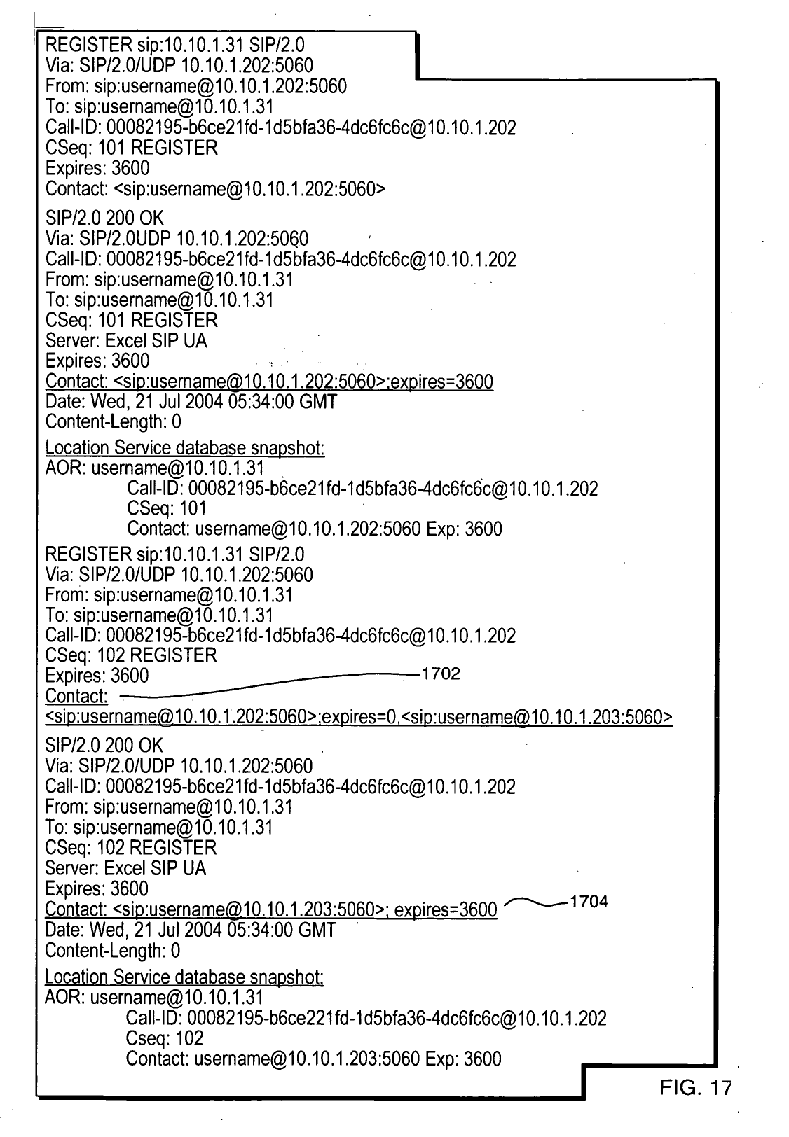

FIG. 17 provides an example of Registration Modification. In the example, the SIP user initially registered with the SIP Registrar with a single contact address with expiration duration of one hour. Later, the user wants to modify the registration record by deleting the first contact address and adding a second contact address with the same expiration during. This can be done by re-sending the SIP REGISTER request. More specifically, the first contact address is deleted in line 1702. The new contact address is added in line 1704.

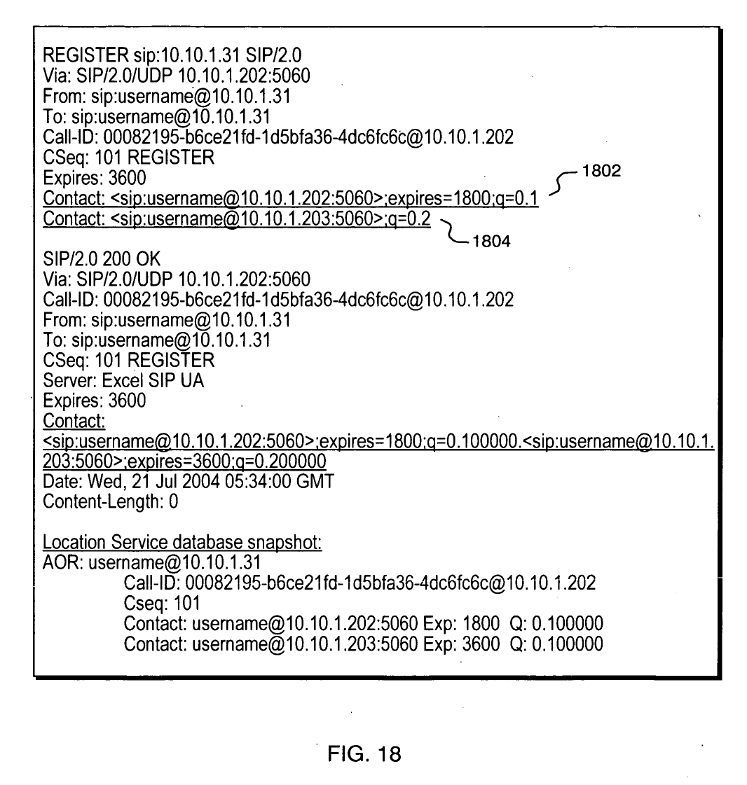

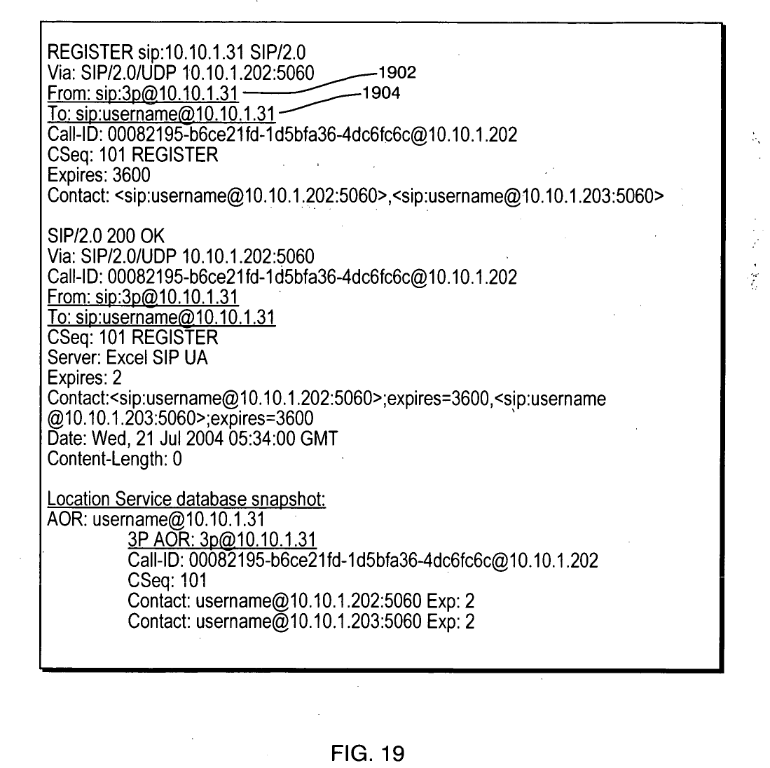

FIG. 18 is an example of performing Registration with Multiple Contacts. Baseline SIP allows a user to register multiple contact addresses for the own AOR or for a third party's AOR (It is noted that Third Party registrations are discussed with reference to FIG. 19). The ability to register multiple contact addresses allows a user to be reached at multiple entity s in a sequential or a parallel (forking) manner depending on the service logic. For example, among the multiple contact addresses that can be used, may be the user's work phone, home phone, mobile phone, PDA, instant messenger, and the like. The user can assign disparate expiration durations for each contact address (individual contact addresses expire independently of each other) to announce his temporal presence at relevant location/entity. The user can also assign unique “q” values to each of the contact addresses to create a prioritized list of the contact addresses. The SIP Registrar residing as the Registration module 332 of the Open SIP Protocol Stack 300 of the present invention supports these features. In the example of FIG. 18, a user registering with the SIP Registrar of the present invention is using two contact addresses, as shown in lines 1802 and 1804, each with its own expiration duration and “q” value (the second contact address lacks the “expires” parameter; in that case the “Expires” header value is used).

The SIP Registrar of the present invention also allows a third party to add, delete, query, and modify registration on another user's behalf. The third party may be another user or an administrative program. This function is illustrated in FIG. 19. The fact that a registration operation is requested by a third party is known by finding a mismatch in the ‘To’ and ‘From’ addresses, as shown in lines 1902 and 1904. In an illustrative embodiment, the SIP Registrar of the present invention does not store a list of valid third parties, thus, if a third party needs to be validated, HTTP digest authentication must be utilized. The example of FIG. 19 shows a third party registering another user. The third party's AOR (the contents of the ‘From’ header field 1902) are maintained in the location service database, in that example.

It is also noted that using SIP Registrar of the present invention, service providers can program (configure) certain local policies within the Registrar. One such policy involves the Registrar checking for the registration duration requested by the end-point, and if the value falls below a certain locally configured minimum, the registration request is denied with a 423 (Interval Too Brief) response, as will be understood by those skilled in the art. The SIP Registrar of the present invention can be readily configured to implement other local policies in a similar manner.

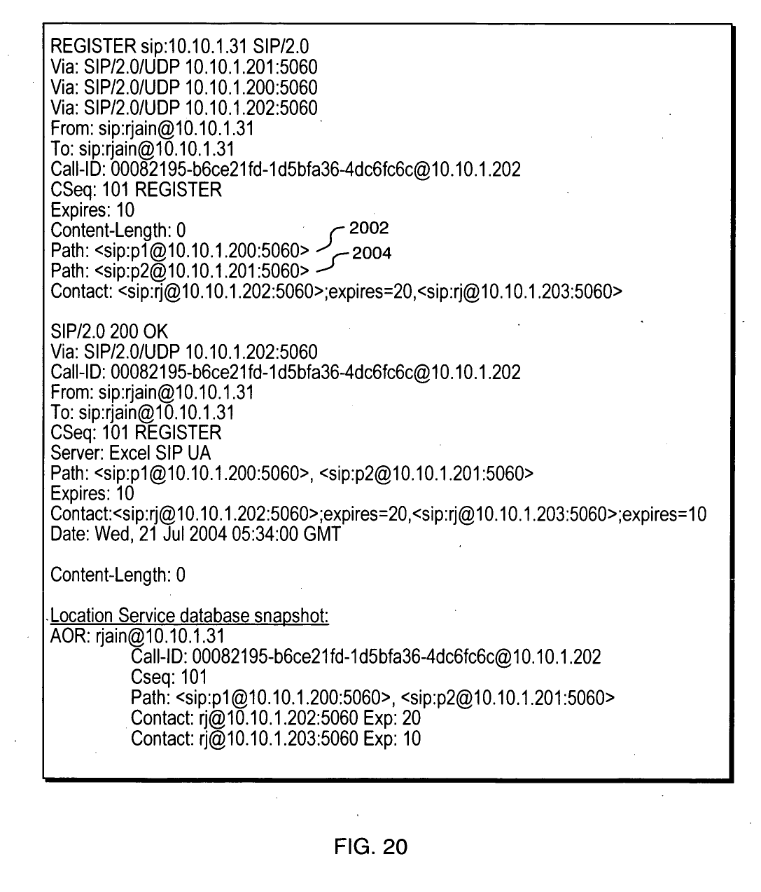

The example of FIG. 20 relates to registering non-adjacent contacts pursuant to RFC 3327. The AOR-Contact bindings created through the registration mechanisms specified in RFC 3261 fail to take into account the addresses of proxy servers that may have been traversed by the SIP messages. In most wired networks, the user can be contacted directly once his/her contact addresses are known. However, in some cases if the user is roaming, in order to contact the user from the user's home network, these proxy servers must be back tracked. This scenario is typically seen in wireless networks (most notably 3GPP networks) where there is no other way to contact the user other than going through the same set of proxy servers that the user went through to register his entity at the Registrar. The Open SIP Protocol Stack of the present invention supports RFC 3327 to solve this problem. RFC 3327 adds a new header to SIP called ‘Path’ that each proxy adds to downstream REGISTER messages. The ‘Path’ header essentially contains the SIP URI of the proxy, and as a Registrar, the Open SIP Protocol Stack of the present invention is responsible for storing all the ‘Path’ headers present in a SIP REGISTER request within the user's registration record. Once stored in the location service, the ‘Path’ information can be fetched by any party interested in contacting the user. The example of FIG. 20 reflects a network topology where there are two proxy servers P1 and P2 between the user and the SIP Registrar, as shown in lines 2002 and 2004.

It should be understood by those skilled in the art that the Open SIP Protocol Stack of the present invention allows for a value added customization and configuration of various aspects of many different kinds of SIP-based entities. Many of the changes can be performed in many instances dynamically. The open programmability of the Open SIP Protocol Stack and associated database allows for ready re-programmed and software updates for changing standards.

The foregoing has been a detailed description of the invention. Various modifications and additions can be made without departing from the spirit and scope of the invention. Furthermore, it is expressly contemplated that the various processes, layers, modules and utilities shown and described according to this invention can be implemented as software, consisting of a computer readable medium including programmed instructions executing on a computer, as hardware or firmware using state machines and the like, or as a combination of hardware, software and firmware. Accordingly, this description is meant to be taken only by way of example and not to otherwise limit the scope of the invention.

What is claimed is:

1. A PPL-based software protocol system for use with an Internet telephony entity, comprising:
(A) an open programmable SIP software protocol stack configured to operate in a signaling layer of a software operating system of a telecommunications device, which signaling layer is disposed between a network and a call processing layer of a telecommunications device, including:
a syntax/encoding software layer that receives SIP messages;
an open programmable transport software layer comprising a plurality of state machines, said transport software layer loading information about a particular transport protocol being used in a given transaction dynamically into respective state machines; and
an open programmable transaction software layer comprising a plurality of state machines, said transaction software layer loading information about the particular transaction dynamically into respective state machines for that transaction; and
a transaction user core layer that performs functions determined by said incoming SIP messages; and
(B) an associated configuration database that includes multiple data entries about individual attributes that apply to particular transactions such that specific data about an individual selected attribute is retrieved from said database and loaded into the respective state machines for that transaction.

2. The software protocol system as defined in claim 1 further comprising said configuration database storing configuration data about calls and transactions applicable to one or more entities in use in a network, said configuration database including a Session Group Profile Table that includes entries about attributes of at least one of a call, a transaction and a session identified by a Session Group Profile Identifier.

3. The software protocol system as defined in claim 2 wherein said Session Group Profile Identifier points to configuration data and PPL variants which apply to the particular call, transaction or session.

4. The software protocol system as defined in claim 1 wherein said transaction user core layer includes processes for said protocol stack to act as one of the following: a SIP Registrar, a SIP Stateful Proxy, SIP Stateless Proxy and back-to-back user agent.

5. The software protocol system as defined in claim 1 further comprising a hash table and hashing function module for performing a hashing technique on an input to index into a record in a table that relates to that input.

6. The software protocol system as defined in claim 5 wherein said hashing technique is performed for transaction matching and said input is a Call_ID and said record is a call context for that Call-ID.

7. The software protocol system as defined in claim 5 wherein said hashing technique is performed with respect to a Layer 3 Call Agent.

8. The software protocol system as defined in claim 5 wherein said hashing technique is performed in registration and said input is an Address of Record and said record is one or more Contact Addresses.

9. The software protocol system as defined in claim 1 further comprising a software process for dynamically editing selected state machines.

10. The software protocol system as defined in claim 8 wherein said a state machine is editable such that a message to be sent as a response is changed.

11. The software protocol system of the present invention wherein said software protocol system is deployed as a SIP Protocol Stack in one or more of the following entities: user agent, proxy server and application server.

12. A computer readable medium for performing SIP protocol functions in a SIP entity operating in an Internet telephony environment, including program instructions for performing the steps of:
receiving a SIP INVITE message for an incoming call;
reading data in the INVITE message about said incoming call;
determining which state machines are involved in the transactions related to the call;
invoking a Session Group Profile entry as a mini-stack from an associated database that is associated with a particular attribute for that transaction;
loading respective state machines with data applicable to that particular transaction as set forth in the mini-stack; and
running the call according the behavior specified in the state machine as loaded with applicable data.

13. The computer readable medium as defined in claim 12 wherein said attribute is the transport protocol of the incoming call.

14. The computer readable medium as defined in claim 12 wherein said attribute is a timer that is applicable to the incoming call.

15. The computer readable medium as defined in claim 12 wherein said steps are performed with respect to an outgoing call.

16. The computer readable medium as defined in claim 12 including the further step of runtime binding a call to a Session Group Profile identifier which points to configuration data for that call and to a corresponding PPL variant identifier for that call.
